(19) United States
(12) Patent Application Publication
(10) Pub. No.: US 2022/0242332 A1
(43) Pub. Date: Aug. 4, 2022

(54) DEVICE MOUNT FOR A VEHICLE

(71) Applicant: Spotify AB, Stockholm (SE)

(72) Inventors: Mats BARVESTEN, Stockholm (SE); Andreas Erik CEDBORG, Stockholm (SE); Björn NILSSON, Stockholm (SE); Tobias Christopher Tilman BERNETH, Stockholm (SE)

(73) Assignee: Spotify AB, Stockholm (SE)

(21) Appl. No.: 17/606,385

(22) PCT Filed: Apr. 29, 2020
(86) PCT No.: PCT/EP2020/061931

§ 371 Date: Oct. 25, 2021

(30) Foreign Application Priority Data
Apr. 29, 2019 (SE) 1950514-8

(51) Int. Cl. B60R 11/02

(52) U.S. Cl. CPC B60R 11/02; B60R 2011/0005

(57) ABSTRACT

An apparatus for supporting a media playback device on a structure of a vehicle comprising an optical disc drive, the apparatus comprising an elongate member configured to be inserted into the slot of the optical disc drive and, when inserted, provide a spring force to retain the apparatus in the slot, and an attachment member connected to the elongate member, the attachment member configured to connect the apparatus to the media playback device.

### FIELD

The present disclosure relates to an apparatus for supporting a media playback device. In particular, the disclosure relates to an apparatus for supporting a media playback device in an optical disc drive of a vehicle.

### BACKGROUND

Many people enjoy consuming media content while travelling or during other activities. For example, many drivers and passengers listen to audio content, such as songs, albums, podcasts, audiobooks, and other types of audible content, in vehicles. Typical sources of such audio content in vehicles include media playback devices, such as mobile phones or tablets running audio streaming applications, which can offer a personalized and flexible music-consuming experience using large catalogues of media content available from a media content server.

It is advantageous that such media playback devices are mounted, for example on a dashboard of a vehicle, so that they are easily and safely accessible by a user, for example a driver of the vehicle. Suitable mounting of the device can ensure that a user may easily interact with the device without his or her attention being taken away from important activities such as driving.

However, current mounting arrangements for such media playback devices can be cumbersome to install, due to a number of moving parts and complicated attachment mechanisms for connecting them to the vehicle. Furthermore, such designs are complicated to manufacture and are therefore less suitable for repeated manufacture. Current mounting arrangements further may not provide a secure attachment to a vehicle when the vehicle is in motion, as vibrations that are present when the vehicle is moving may cause the mounting arrangement to become dislodged.

Therefore, there exists a need for an apparatus for supporting a media playback device that provides easy and safe access to the device, is easy to install and manufacture, and provides a secure attachment throughout its use.

### SUMMARY

The present disclosure provides an apparatus that aims to provide at least some of these advantages. In particular, the disclosure relates to a mounting device that can be inserted into the slot of a compact disc (CD) drive, or optical disc drive, of a vehicle to provide a secure connection to the vehicle. The mounting device can then be attached to a media playback device such that the media playback device can be easily seen and accessed by a driver of the vehicle. The mounting device can be inserted and removed as the user desires, so that it can be moved for example between different vehicles. The device has a simple structure that enables it to be manufactured easily and repeatedly.

In accordance with an aspect of the disclosure there is provided an apparatus for supporting a media playback device on a structure of a vehicle comprising an optical disc drive, the apparatus comprising an elongate member configured to be inserted into the slot of the optical disc drive and, when inserted, provide a spring force to retain the apparatus in the slot, and an attachment member connected to the elongate member, the attachment member configured to connect the apparatus to the media playback device.

Optionally, the elongate member is configured to deform when inserted into the slot to provide the spring force. Optionally, the elongate member comprises a resilient material. Optionally, the elongate member is configured to return to its original shape when removed from the slot.

Optionally, the elongate member comprises at least one through hole from an upper surface to a lower surface of the elongate member. Optionally, the elongate member has a curvature along its length. Optionally, the curvature of the elongate member provides the elongate member with a profile having a height larger than the height of the slot.

Optionally, the elongate member further comprises at least one foot configured to contact an inner surface of the slot when the elongate member is inserted into the slot. Optionally, the elongate member comprises a foot at each end, each foot configured to contact a first surface of the slot when the elongate member is inserted into the slot. Optionally, the elongate member comprises a central foot configured to contact a second surface of the slot, opposite the first surface, when the elongate member is inserted into the slot.

Optionally, the attachment member is configured to detachably connect the apparatus to the media playback device. Optionally, the attachment member comprises a magnetic element. Optionally, the magnetic element is removably attached to the apparatus. Optionally, the attachment member is translatably connected to a rail that extends along the length of the elongate member. Optionally, the attachment member comprises a ball joint. Optionally, the apparatus further comprises a stop between the elongate member and the ball joint, the stop configured to prevent the ball joint from being inserted into the slot. Optionally, at least the elongate member and the ball joint are formed as a unitary structure.

### BRIEF DESCRIPTION OF THE DRAWINGS

Exemplary embodiments of the disclosure shall now be described with reference to the drawings in which:

FIG. 1 illustrates an example system for streaming media content for playback;

FIG. 2 illustrates a mounting device according to an embodiment;

FIG. 3A illustrates another view of the mounting device of FIG. 2;

FIG. 3B illustrates another view of the mounting device of FIG. 2;

FIG. 3C illustrates another view of the mounting device of FIG. 2;

FIG. 4A illustrates a magnetic assembly according to an embodiment;

FIG. 4B illustrates a cross-sectional view of a mounting device and attachment plate according to an embodiment;

FIG. 5 illustrates a mounting device according to an embodiment; and

FIG. 6 illustrates a mounting device when inserted into the slot of an optical disc drive.

Throughout the description and the drawings, like reference numerals refer to like parts.

### SPECIFIC DESCRIPTION

Many people enjoy listening to audio content, such as songs, albums, podcasts, audiobooks, and other types of audible content, in vehicles. It is typical for a driver or and passenger to bring a media playback device running audio streaming applications, such as a mobile phone, into a vehicle in order to offer a personalized and flexible music-consuming experience using large catalogues of media content available from a media content server.

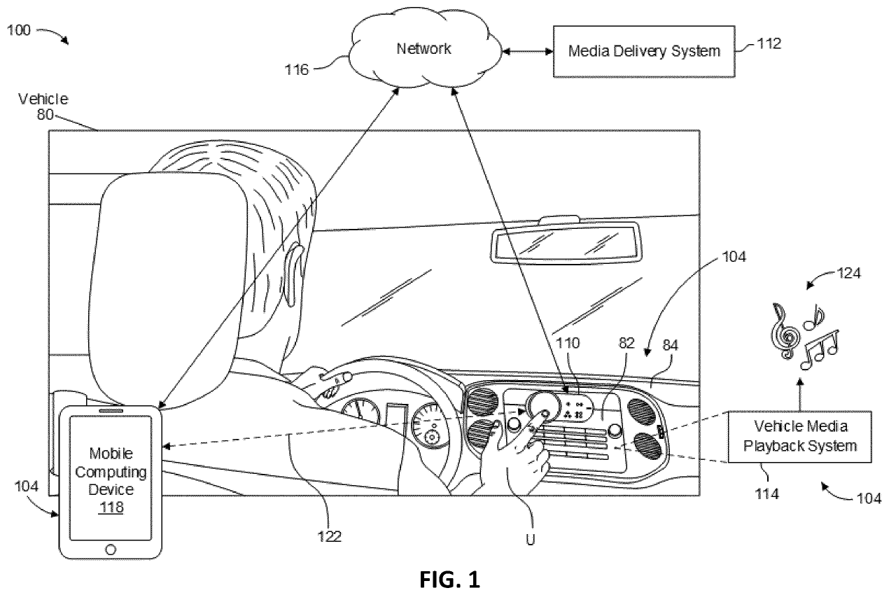

FIG. 1 illustrates an example system 100 for streaming media content for playback that can be used in a vehicle 80. The system 100 includes one or more media playback devices 104 configured to play media content. Examples of the media playback devices 104 include one or more of a personal media streaming appliance (PMSA) system 110, and a mobile computing device 118. The system 100 also includes one or more of a media delivery system 112 and a vehicle media playback system 114. Data communication within the system 100 can occur using one or more of a data communication network 116 and an in-vehicle wireless data communication network 122. The system 100 may be substantially as described in European patent application no. 18170555.9, and details of its structure and function will not be discussed here. In brief, the system 100 is operable to generate a media output 124 to play media content in the vehicle 80. The vehicle 80 includes a dashboard 82 or a head unit 84. In many cases, a user U wishes to mount a media playback device 104, for example the PMSA system 110, within the vehicle 80, for example on the dashboard 82. Other examples of media playback devices 104 include smartphones, portable media players, tablets and the like.

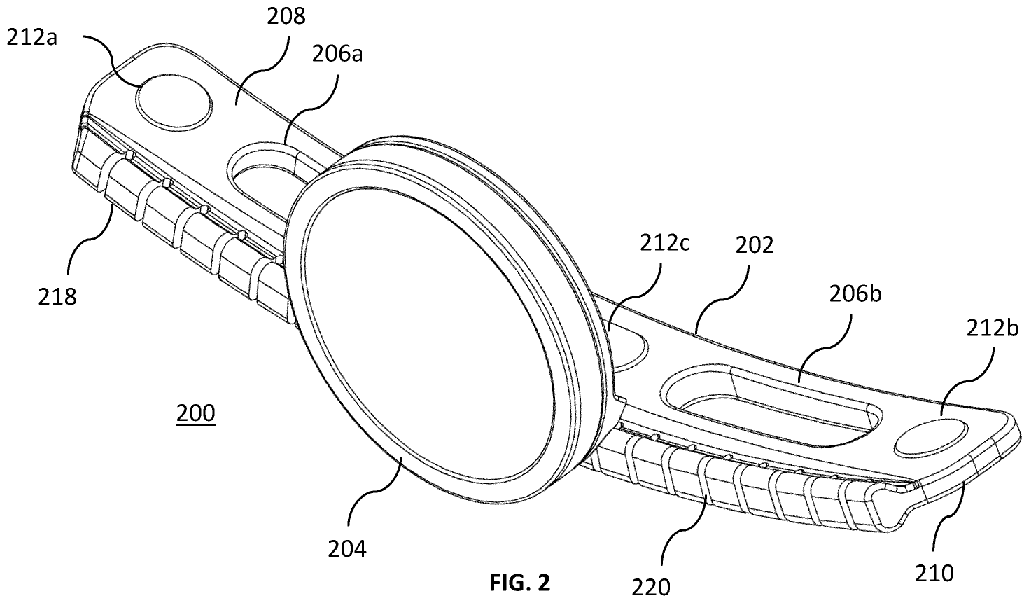

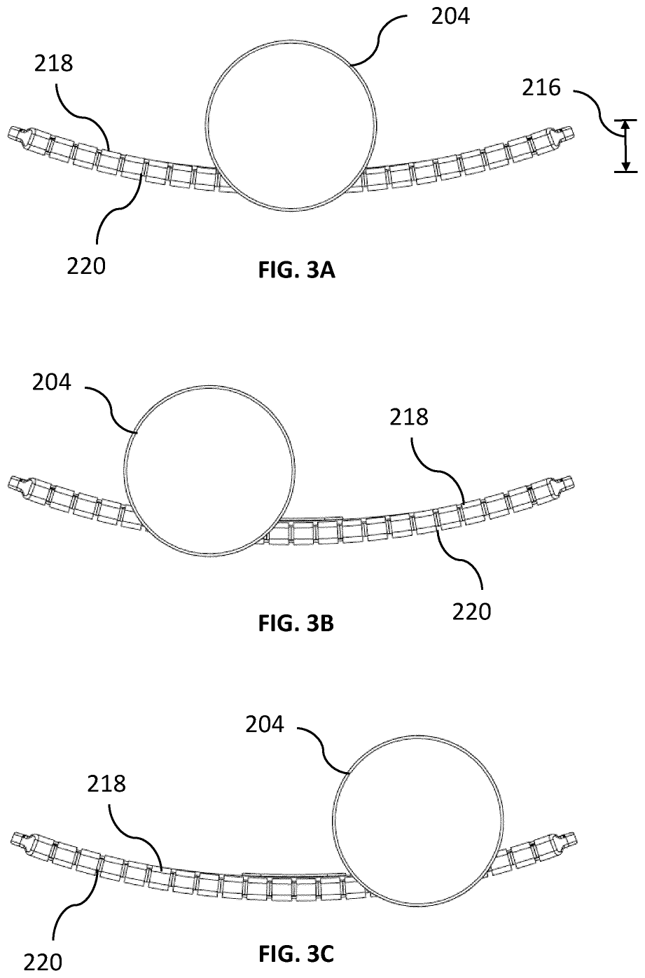

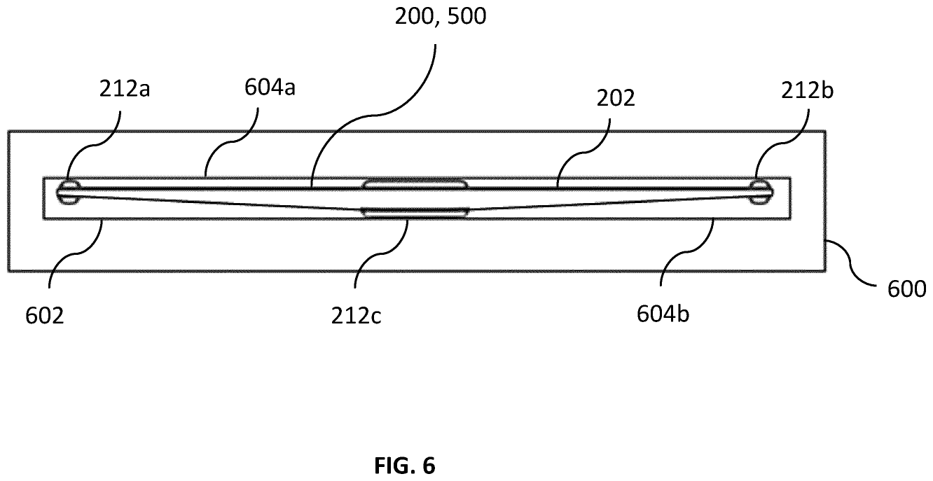

FIGS. 2 and 3A-C illustrate a mounting device 200 for supporting a media playback device 104 within the vehicle 80. Specifically, the mounting device 200 is configured to attach to the slot of an optical disc drive, or CD drive, of the vehicle 80 (as will be described in relation to FIG. 6), and thus provide a secure connection to the vehicle 80. The optical disc drive of a vehicle 80 is generally in a prominent position on the dashboard 82 of the vehicle 80, and is therefore a suitable position for the mounting of a media playback device 104. A media playback device 104 can be attached to the mounting device 200 such that it is mounted in the vehicle 80 and can be easily seen and interacted with by the user U.

As shown in FIG. 2, the mounting device 200 comprises an elongate member 202 and an attachment member 204. The elongate member 202 is configured to be inserted into the slot of an optical disc drive. As such, the elongate member 202 has a length and thickness that generally correspond to the width and height of the slot of an optical disc drive. It will be appreciated that the length of the elongate member 202 should be such that the elongate member 202 can be inserted into the slot. The elongate member 202 may also have a depth that is sufficient to hold the mounting device 202 in an entrance portion of the slot, without extending into the working components of the optical disc drive. The attachment member 204 is connected to the elongate member and is configured to connect the mounting device 200 to a media playback device 104. Whilst this description refers to a device configured to be inserted into the slot of an optical disc drive, it will be appreciated that the mounting device 200 could equally be inserted into a similarly or suitably sized recess located somewhere else in the vehicle. The elongate member 202 may have a number of tabs (not shown) along its length to enable easier removal of the mounting device 200 from a slot after it has been inserted.

In some embodiments, the elongate member 202 is formed such that it cannot be inserted into the slot of an optical disc drive without some deformation. The elongate member 202 may be constructed in such a manner that, when it is deformed, it provides a force that acts against the deformation in order to bring the elongate member 202 back towards its original shape. This force is a type of spring force, in the same way that a spring provides a resistive force when it is compressed. As will be discussed in relation to FIG. 6, once deformed, the elongate member 202 can be inserted into the slot of an optical disc drive, and the presence of the resulting spring force acts against the inner surfaces of the slot to hold the mounting device 200 in position. This provides a secure connection between the mounting device 200 and the vehicle. As discussed above, the elongate member 202 may be dimensioned to act against an entrance portion of the slot, without affecting the working components of the optical disc drive.

In some embodiments, the elongate member 202 is curved along its length, as shown in FIGS. 3A-C. This curvature provides the elongate member 202 with a profile having a height 216 larger than the height of the slot of the optical disc drive of the vehicle 80. This ensures that, when the elongate member 202 is inserted into the slot, it is deformed to provide the spring force discussed above. The curvature can be selected such that a minimum deformation of the elongate member 202 is required to provide an adequate spring force to retain the elongate member 202 in the slot. In other embodiments, the elongate member may be generally V-shaped. That is to say, the profile height 216 is larger than the slot height, with an elongate member 202 having straight portions extending from a centre of the elongate member 202, rather than curved portions. FIG. 2 shows the elongate member 202 curving up towards each end from the centre. The mounting device 200 can be installed in a slot either way up, such that the mounting device 200 works just as well if it is oriented in the opposite sense to that shown in FIG. 2 (with the elongate member 202 curving down from the centre instead of up).

It may be desired that the mounting device 200 be reusable, such that it can be installed numerous times in the same or different vehicles. To achieve this, the elongate member 202 may be made of a resilient material such that, once it is deformed, it can return to its original shape. In such embodiments, the elongate member 202 may be formed such that it deforms and returns to its original shape every time it is inserted and removed from the slot of an optical disc drive. To achieve this, the mounting device 200 may be formed of a plastic material, for example a thermoplastic resin. One such material is the Lexan™ copolymer EXL4419, available from SABIC of Riyadh, Saudi Arabia. It will be apparent to the person skilled in the art that other materials having the relevant resilience properties could also be used.

If the mounting device 200 is left in the slot, and therefore under load, for extended periods of time, or is inserted and removed repeatedly from the slot, structural issues such as creep may arise. Therefore, in some embodiments, the elongate member 202 is provided with at least one through hole 206. As shown in FIG. 2, the through holes 206a-b extend from an upper surface 208 to a lower surface 210 of the elongate member 202. The through holes 206a-b serve to reduce the stiffness of the elongate member 202, thus ensuring that it is capable of undergoing increased duration of load without failure or losing its resilience. This extends the lifetime of the mounting device 202. Whilst two through holes 206a-b are shown, it will be appreciated that any suitable number of holes could be used to provide the required creep mitigation properties. In the embodiment of FIG. 2, the through holes 206a-b are generally elliptical, although it will be envisaged that other shapes could also be used to provide creep mitigation.

In some embodiments, the elongate member 202 comprises at least one foot 212 configured to contact an inner surface of the slot when the elongate member 202 is inserted into the slot (as will be described in relation to FIG. 6). The presence of a foot 212 may provide an area of increased friction against the inner surface of the slot when the mounting device 200 is installed, in order to ensure that the mounting device 200 is stably attached in the slot. In some embodiments, the foot 212 may be formed of a softer material than the rest of the elongate member 202, in order to provide a softer contact point with the inner surface of the slot and mitigate any damage to the slot during installation of the mounting device 200. In some examples, the foot 212 may be formed of rubber. In the embodiment shown in FIG. 2, the elongate member 202 comprises a foot 212a-b at each end. Each end foot 212a-b may extend through the elongate member 202 such that a portion of each foot protrudes from each side of the elongate member 202, or may be implemented as separate foot elements on each side of the elongate member 202. Each end foot 212a-b is configured to contact a surface of the slot when the elongate member 202 is inserted into the slot. The feet may each contact the slot on one or both sides of the elongate member 202 when inserted.

In the embodiment shown, the elongate member 202 also comprises a central foot 212c. The central foot 212c may also extend through the elongate member 202 such that a portion of the foot protrudes from each side of the elongate member 202, or may be implemented as separate foot elements on each side of the elongate member 202. The central foot 212c has a lower part that is configured to contact a bottom surface of the slot when the elongate member 202 is inserted into the slot. The central foot 212c also has an upper part that is configured to contact a top surface of the slot when the elongate member 202 is inserted into the slot. In this way, a foot is present at each contact point of the elongate member 202 with the slot when the elongate member 202 is inserted. This will be shown in relation to FIG. 6. This can provide a more secure and/or softer contact between the mounting device 200 and the slot of the optical disc drive at all necessary points. It will be envisaged that the exact location of the feet 212a-c on the elongate member 202 may be different depending on where the elongate member 202 contacts the slot when installed. For example, while three feet 212a-c are shown, at the ends and in the centre of the elongate member 202, any suitable number of feet 212 could be used at the relevant contact points between the elongate member 202 and the slot when the mounting device 200 is installed. In some embodiments, the entire elongate member 202 may be covered with a soft frictional material such as rubber.

As discussed above, the attachment member 204 is configured to connect the mounting device 200 to a media playback device 104. In some embodiments, the attachment member 204 is configured to permanently connect the mounting device 200 to a media playback device 104. In other embodiments, the attachment member 204 is configured to detachably connect the mounting device 200 to a media playback device 104. In this way, the user U can easily switch between different media playback devices 104 using the same mounting device 200, and need not have a separate mounting device 200 for each media playback device 104. This may also enable the user U to switch between media playback devices 104 while the mounting device 200 is installed. This increases the usability of the mounting device 200. In some embodiments, the attachment member 204 connects the mounting device 200 to a media playback device 104 indirectly. That is to say, the attachment member 204 connects to an intermediate device, which in turn connects to the media playback device 104.

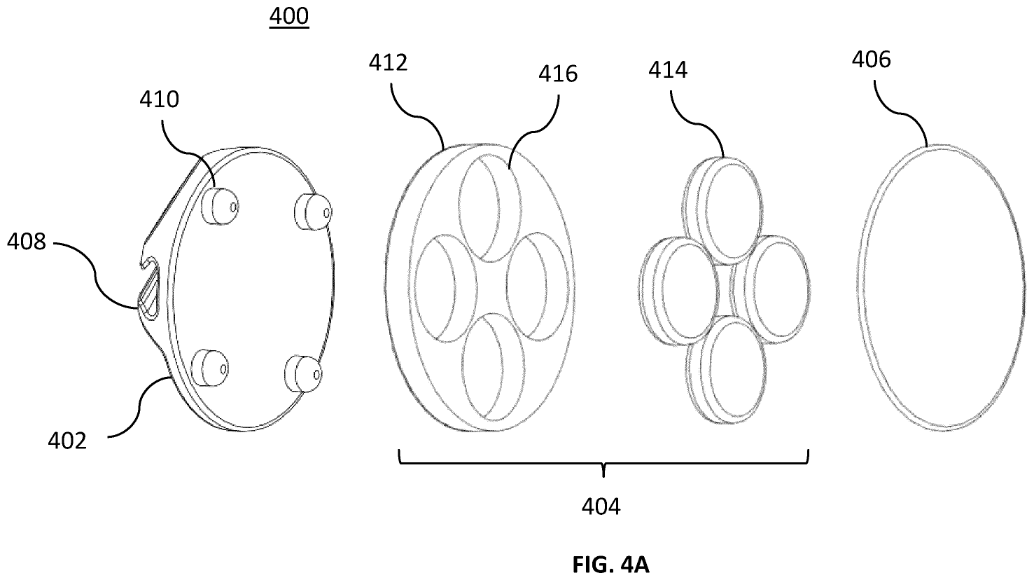

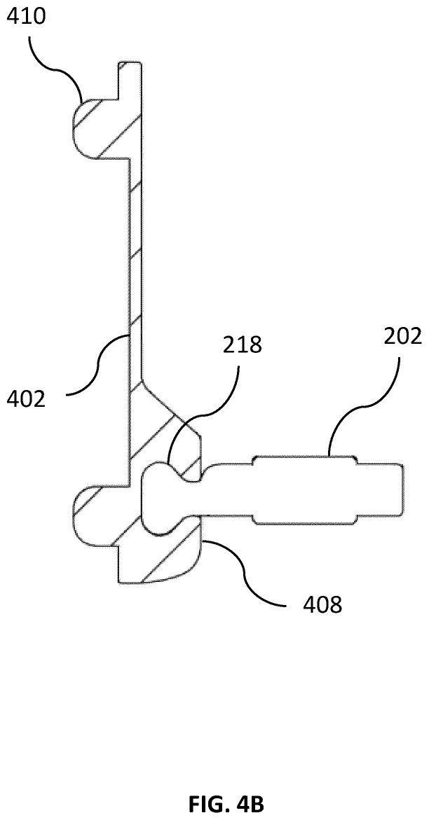

In the embodiment shown in FIG. 2, the attachment member 204 comprises a magnetic assembly. The magnetic assembly will be described in more detail in relation to FIGS. 4A, and 4B The magnetic assembly, or other type of a magnetic element of an attachment member 204, may connect to a corresponding ferromagnetic portion of a media playback device 104 or an intermediate device. It will be envisaged that many other types of attachment could be used to connect the mounting device 200 to a media playback device 104. For example, the connection between the mounting device 200 and a media playback device 104 may be a ball joint. In one embodiment, the attachment member 204 may be connected to a dock via a ball joint, and the dock magnetically connected to a media playback device 104. In some embodiments, the attachment member 204 may be a flat face with an adhesive part, such that a media playback device 104 can be attached to the mounting device 200 by adhesion. The attachment member 204 may be configured to attach to a media playback device at a point offset from the axis of the elongate member 202. In FIG. 2, this is shown as being above the axis. This enables the media playback device 104 to be mounted at a higher or lower position relative to a slot, dependent on the orientation of the mounting device 200 when it is inserted.

In the embodiment shown in FIG. 2, the attachment member 204 is connected to the elongate member 202 on a rail 218. The rail 218 is formed along a front edge of the elongate member 202, and may extend from one end of the elongate member 202 to the other. The connection between the attachment member 204 and the rail 218 enables the attachment member 204 to be translated along the length of the elongate member 202. This allows the attachment member 204 to be placed in a number of different positions along the length of the elongate member 202, allowing the user U to choose a position to attach a media playback device 104 to the mounting device 200.

The presence of the rail 218 and the attachment element 204 may prevent the mounting device 200 being inserted far enough into the slot to interfere with the working components of the optical disc drive, for example the optical path, laser and lens. The rail 218 and/or the attachment element 204 may have dimensions larger than the corresponding dimensions of the slot of the optical disc drive. For example, the rail 218 and/or the attachment element 204 may have a height larger than the height of the slot. In this way, the presence of the rail 218 and/or the attachment element 204 prevents the mounting device 200 being inserted too far into the slot. Similarly, this prevents the entire mounting device 200 from getting stuck in the optical disc drive.

FIGS. 3A-C show the attachment member 204 in three different positions along the rail 218. In FIG. 3A, the attachment member 204 is located generally at the centre of the rail 218. In FIG. 3B, the attachment member 204 is located to the left of the centre of the rail 218. In FIG. 3C, the attachment member 204 is located to the right of the centre of the rail 218. A number of notches 220 formed along the length of the rail 218. The notches 220 provide mitigation against the structural effects on the elongate member 202 of repeated or extended use of the mounting device 200. The rail 218 and the notches 220 also deform when the mounting device 200 is inserted into a slot, which prevents the attachment member 204 from sliding along the rail 218 and locks it in position. The notches 220 are formed at regular intervals along the length of the rail 218. In other embodiment, the notches 220 may be formed at irregular intervals along the length of the rail 218. The total number of notches 220 may be different from that shown. In other embodiments, the rail 218 may have no notches, and provide a smooth surface along which the attachment member 204 can be translated.

As discussed above, the mounting device 200 has an attachment member 204 comprising a magnetic assembly. An example of a magnetic assembly 400 is shown in FIG. 4A. The magnetic assembly 400 comprises an attachment plate 402, a magnet layer 404 and a contact layer 406. These elements can be assembled together and attached on one side to a rail 218.

The attachment plate 402 comprises a clasp 408 on its rear face for connection to the rail 218. The clasp 408 has a shape corresponding to that of the rail 218, such that the attachment plate can be slid onto the rail 218 from either end. The attachment plate 402 is then slidably connected to the rail 218, such that it can be slid along the length of the rail without being removed between the two ends. This can be seen in FIG. 4B, which shows a cross-sectional view of the attachment plate 402 when connected to the rail 218 of the mounting device 200. The attachment plate 402 is made of a ferromagnetic material, for example steel. This enables a magnetic connection between the attachment plate 402 and the magnet layer 404. On its front face, the attachment plate 402 comprises a number of studs 410 for connection to corresponding recesses (not shown) on the rear face of the magnet layer 404. Four studs 410 are shown in FIG. 4A, but it will be appreciated that any number and orientation of studs 410 may be used that achieves the desired attachment between the attachment plate 402 and the magnet layer 404.

The magnet layer 404 comprises a base 412 and a number of magnets 414. The base 412 has a number of recesses 416 formed in its front face. It will be appreciated that the base 412 may additionally or alternatively have a number of recesses 416 formed in its rear face. Each recess 416 is configured to receive a respective magnet 414. The magnets provide a magnetic field for attachment of the magnet layer 404 to the attachment plate 402 on one side, and attachment of the magnetic assembly 400 to a peripheral device, such as a media playback device 104 or an intermediate device, on the other side. The peripheral device may comprise a corresponding ferromagnetic portion such that a magnetic attachment is made between the magnetic assembly and the peripheral device. Four magnets are shown in FIG. 4A, but it will be appreciated that any number and orientation of magnets may be used that achieves the desired attachment between a mounting device 200 and a peripheral device.

The rear face of the base 412 comprises a number of recesses (not shown) for receipt of the studs 410 of the attachment plate 402. The interaction between the studs 410 and the recesses prevents relative rotation between the attachment plate 402 and the magnet layer 404 when they are assembled together. It will be appreciated that, in some embodiments, the studs could be present on the rear face of the base 412 with corresponding recesses on the front face of the attachment plate 402.

The magnetic connection between the attachment plate 402 and the magnet layer 404 enables the sub-assembly of the magnet layer 404 and contact layer 406 to be separated from the attachment plate 402. The sub-assembly can then be connected to another mounting device 200 having a suitable attachment plate 402. As such, the sub-assembly can be used with a number of different mounting devices.

The contact layer 406 is attached on the front of the magnet layer 404. This may be achieved by adhesion, or any other suitable means. In use, the contact layer 406 is placed in contact with a peripheral device. In some embodiments, the contact layer 406 is formed of a frictional material such as rubber, to provide a more robust connection to the peripheral device.

By using a magnetic attachment member 204, such as an attachment member 204 comprising the magnetic assembly 400 shown in FIG. 4A, a mounting device 200 can be detachably connected to a peripheral device, such as a media playback device 104. In this way, the user U can easily switch between different media playback devices 104 using the same mounting device 200, and need not have a separate mounting device 200 for each media playback device 104. This may also enable the user U to switch between media playback devices 104 while the mounting device 200 is installed. It will be appreciated that the structure and function of a magnetic attachment member 204 may be different from that shown in FIG. 4A whilst still performing the function of detachably connecting the mounting device 200 to a peripheral device.

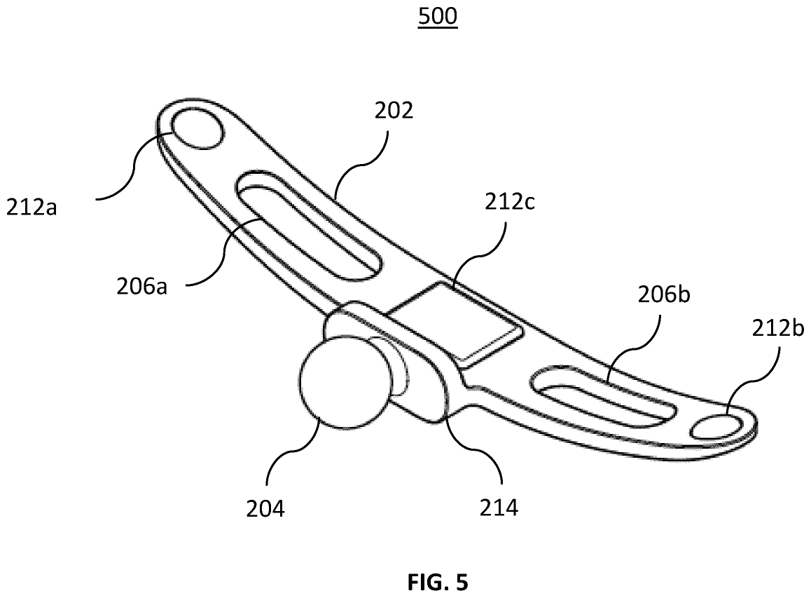

FIG. 5 illustrates an alternative mounting device 500 configured to attach to the slot of an optical disc drive of a vehicle 80 for supporting a media playback device 104 within the vehicle 80. The mounting device 500 comprises an elongate member 202 having through holes 206 and feet 212, all of which are substantially similar in structure and function to those described in relation to the mounting device 200 shown in FIG. 2. However, rather than a rail 218 and an attachment member 204 comprising a magnetic assembly as shown in FIG. 2, the mounting device 500 comprises an attachment member 204 that is connected directly to the elongate member 202.

The attachment member 204 shown in FIG. 5 is a ball joint, although it will be envisaged that many other types of attachment could be used to connect the mounting device 500 to a media playback device 104. For example, the connection between the mounting device 500 and a media playback device 104 may be a magnetic connection. In one embodiment, the attachment member 204 may be connected to a dock via a ball joint, and the dock magnetically connected to a media playback device 104. In some embodiments, the attachment member 204 may be a flat face with an adhesive part, such that a media playback device 104 can be attached to the mounting device 500 by adhesion.

In some embodiments, the attachment member 204 is tilted with respect to the principal horizontal plane of the mounting device 500. As optical disc drives in vehicles tend to be placed below the user's eye-level, employing a tilted attachment member 204 allows a screen of the media playback device 104 to be directed towards the user's eyes, enabling easier and safer interaction with the device 104.

To prevent the mounting device 500 being inserted far enough into a slot to interfere with the working components of the optical disc drive, in some embodiments, the mounting device 500 comprises a stop 214. The stop 214 may be located between the elongate member 202 and the attachment member 204. The stop 214 may have dimensions larger than the corresponding dimensions of the slot of the optical disc drive. For example, the stop 214 may have a height larger than the height of the slot. In this way, the presence of the stop 214 prevents the mounting device 500 being inserted too far into the slot. Similarly, the stop 214 prevents the entire mounting device 500, in particular the attachment member 204, from being inserted into the slot. This prevents the mounting device 500 from getting stuck in the optical disc drive.

As the mounting device 500 has a smaller number of components than many known mounting arrangements, and has no moving parts, it has a relatively simple structure. This enables it to be manufactured as a single piece. In some embodiments, the whole mounting device 500 may be manufactured as a single piece. In other embodiments, at least the elongate member 202 and the attachment member 204 are formed as a unitary structure. For example, in one embodiment, the elongate member 202, the attachment member 204 and the stop 214 are formed as a unitary structure. In these embodiments, the feet 212a-c may then be formed separately, for example from a different material as discussed above, and assembled with the unitary structure to form the complete mounting device 500. The mounting device 500 may be formed, for example, by injection moulding.

FIG. 6 illustrates a mounting device 200, 500 when inserted into the slot 602 of an optical disc drive 600. As discussed above, the elongate member 202 is configured to deform when inserted into the slot 602. As can be seen in FIG. 6, the elongate member 202 has deformed to have a shallower curvature than that shown in FIGS. 2, 3 and 5. In some embodiments, the elongate member 202 may be substantially flat when deformed and inserted into the slot 602. In this way, the elongate member 202 provides a spring force that acts to return the elongate member 202 towards its original shape. This spring force acts against the inner surfaces 604a-b of the slot 602, which thus retains the mounting device 200 in the slot 602. The material from which the elongate member 202 is formed can be selected such that it has the requisite stiffness to provide a firm and secure connection when deformed and inserted into the slot 602.

The spring force acts through the feet 212a-c. The end feet 212a-b contact the upper surface 604a of the slot 602 and provide a force against the upper surface 604a. The central foot 212c contacts both the upper and lower surfaces 604a-b of the slot 602, and principally provides a force against the lower surface 604b. It will be appreciated that the contact points may be different with different designs or orientations of the mounting device 200 and/or the slot 602. In one example, the end feet 212a-b could contact both the upper and lower surfaces 604a-b of the slot 602 if the slot 602 is sufficiently narrow. For example, the mounting device 200 could be installed in the opposite sense, such that the end feet 212a-b contact the lower surface 604b of the slot 602 and the central foot 212c acts principally against the upper surface 604a of the slot.

As discussed above, in some embodiments the elongate member 202 is configured to return to its original shape when removed from the slot 602. This ensures that the mounting device 200, 500 can be removed and reused multiple times in the same vehicle or different vehicles. For example, the user U may not have a single main vehicle, and may want to use the mounting device in various vehicles, for example rental cars. In another example, certain users may find it easier to attach a media playback device 104 to the mounting device when the mounting device 200, 500 is not inserted in the slot 602. When the elongate member 202 is configured to return to its original shape when removed from the slot 602, the user U can remove the mounting device 200, 500, detach a first media playback device 104, attach a second media playback device 104, and then reinsert the mounting device 200, 500 such that the second media playback device 104 is now mounted securely in the vehicle.

A mounting device 200, 500 such as that described above is able to securely support a media playback device in a vehicle, at a location that is easy and safe for a user to interact with. It is simple to install and remove and can be reused numerous times. Due to its simple design, the mounting device 200, 500 is easy to manufacture. It will be envisaged that the mounting device 200, 500 is suitable for any vehicle having an optical disc drive. It will also be envisaged that the mounting device 200, 500 could be used to support a media playback device in a slot of an optical disc drive outside of a vehicle, for example in a home or office environment. Similarly, it will be appreciated that the mounting device 200, 500 could equally be used to support a media playback device in a similarly or suitably sized recess located somewhere outside of a vehicle.

The foregoing description of embodiments of the present disclosure has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

1. An apparatus for supporting a media playback device on a structure of a vehicle comprising an optical disc drive, the apparatus comprising:
an elongate member configured to be inserted into the slot of the optical disc drive and, when inserted, provide a spring force to retain the apparatus in the slot; and
an attachment member connected to the elongate member, the attachment member configured to connect the apparatus to the media playback device.

2. The apparatus of claim 1, wherein the elongate member is configured to deform when inserted into the slot to provide the spring force.

3. The apparatus of claim 1, wherein the elongate member comprises a resilient material.

4. The apparatus of claim 3, wherein the elongate member is configured to return to its original shape when removed from the slot.

5. The apparatus of claim 1, wherein the elongate member comprises at least one through hole from an upper surface to a lower surface of the elongate member.

6. The apparatus of claim 1, wherein the elongate member has a curvature along its length.

7. The apparatus of claim 6, wherein the curvature of the elongate member provides the elongate member with a profile having a height larger than the height of the slot.

8. The apparatus of claim 1, wherein the elongate member further comprises at least one foot configured to contact an inner surface of the slot when the elongate member is inserted into the slot.

9. The apparatus of claim 8, wherein the elongate member comprises a foot at each end, each foot configured to contact a first surface of the slot when the elongate member is inserted into the slot.

10. The apparatus of claim 8, wherein the elongate member comprises a central foot configured to contact a second surface of the slot, opposite the first surface, when the elongate member is inserted into the slot.

11. The apparatus of claim 1, wherein the attachment member is configured to detachably connect the apparatus to the media playback device.

12. The apparatus of claim 1, wherein the attachment member comprises a magnetic element.

13. The apparatus according to claim 12, wherein the magnetic element is removably attached to the apparatus.

14. The apparatus according to claim 12, wherein the attachment member is translatably connected to a rail that extends along a length of the elongate member.

15. The apparatus of claim 1, wherein the attachment member comprises a ball joint.

16. The apparatus of claim 15, further comprising a stop between the elongate member and the ball joint, the stop configured to prevent the ball joint from being inserted into the slot.

17. The apparatus of claim 15, wherein at least the elongate member and the ball joint are formed as a unitary structure.
